(19) United States
(12) Patent Application Publication
(10) Pub. No.: US 2012/0031087 A1
(43) Pub. Date: Feb. 9, 2012

(54) HYDRAULIC CIRCUIT WITH MULTIPLE PUMPS

(76) Inventors: Dennis Reynolds, Fort Wayne, IN (US); Amir Shenouda, Chicago, IL (US)

(21) Appl. No.: 13/263,864

(22) PCT Filed: Apr. 8, 2010
(86) PCT No.: PCT/US10/30335

§ 371 Date: Oct. 11, 2011

Related U.S. Application Data
(60) Provisional application No. 61/167,618, filed on Apr. 8, 2009.

(51) Int. Cl. F15B 11/08

(52) U.S. Cl. 60/429

(57) ABSTRACT

A hydraulic circuit includes at least one actuator that may be powered for performing a function. A plurality of valves are associated with the at least one actuator for controlling a flow of fluid into and out of the at least one actuator. The hydraulic circuit also includes multiple pumps for supplying fluid to the at least one actuator. The multiple pumps includes a first pump for primarily powering the at least one actuator for movement in a first direction and a second pump for primarily powering the at least one actuator for movement in a second direction, opposite the first direction.

### FIELD OF INVENTION

This invention is related to a hydraulic circuit and particularly, to a hydraulic circuit having multiple pumps for supplying fluid to an actuator.

### BACKGROUND OF THE INVENTION

Some known hydraulic circuits, such as those commonly used in mobile machinery, for example, excavators, include two pumps. Since an excavator includes a minimum of four separate functions (boom, arm, bucket, and swing), each pump acts as a primary source for two of the functions. For example, in most excavator circuits, a first pump acts as the primary hydraulic fluid source for the swing and bucket functions and acts as a secondary hydraulic fluid source for the boom function during raising operation; while a second pump acts as the primary hydraulic fluid source for the boom and arm functions and acts as a secondary hydraulic fluid source for the bucket function. As a result of this design, during operation of the excavator, both the first and second pumps often operate at relatively low displacements. For example, during actuation of only the swing and boom function, the first pump may be operating at a 50% displacement for operating the swing, while the second pump may be operating at a 30% displacement for operating the boom. Generally, hydraulic pumps are quite inefficient at partial displacements. As a result of these inefficiencies, hydraulic circuits of the type described above can be costly to operate.

### SUMMARY OF THE INVENTION

According to the invention, a hydraulic circuit is provided that includes at least one actuator that may be powered for performing a function. A plurality of valves are associated with the at least one actuator for controlling a flow of fluid into and out of the at least one actuator. The hydraulic circuit also includes multiple pumps for supplying fluid to the at least one actuator. The multiple pumps includes a first pump for primarily powering the at least one actuator for movement in a first direction and a second pump for primarily powering the at least one actuator for movement in a second direction, opposite the first direction.

According to one embodiment, an electronic controller controls the valves. The controller is responsive to signals from an input device for controlling the valves.

According to an embodiment, the first pump provides fluid into a first supply conduit and, the second pump provides fluid into a second supply conduit. A mixing valve is connected between the first and second supply conduits. The mixing valve is responsive to the controller for fluidly connecting the first and second supply conduits.

According to another embodiment, the hydraulic circuit includes a fluid power storage sub-system having an accumulator and a valve for controlling a flow of fluid out of the accumulator. The controller controls the valve of the fluid power storage sub-system for powering the at least one actuator using fluid from the accumulator.

### BRIEF DESCRIPTION OF THE DRAWINGS

FIG. 1 illustrates a hydraulic circuit constructed in accordance with a first embodiment of the invention;

FIG. 2 illustrates a hydraulic circuit constructed in accordance with another embodiment of the invention; and

FIG. 3 illustrates a hydraulic circuit constructed in accordance with yet another embodiment of the invention.

### DETAILED DESCRIPTION OF THE INVENTION

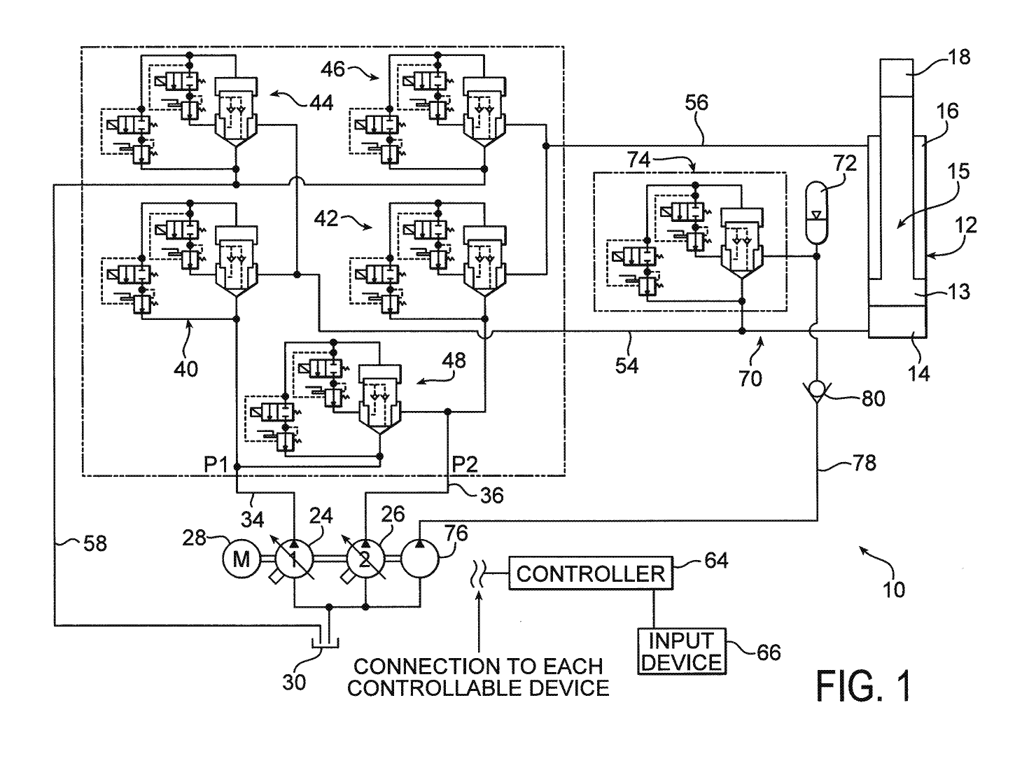

FIG. 1 illustrates a hydraulic circuit 10 constructed in accordance with a first embodiment of the present invention. The hydraulic circuit 10 includes an actuator 12 having a head side chamber 14 and a rod side chamber 16. The head side chamber 14 and the rod side chamber 16 are separated by a piston 13 of a piston/rod assembly 15. The actuator 12 may be powered for operating a function, shown generally by reference numeral 18. The hydraulic circuit 10 also includes two hydraulic pumps 24 and 26. In the embodiment illustrated in FIG. 1, the pumps 24 and 26 are variable displacement pumps that may be actuated overcenter so as to act like motors. The pumps 24 and 26 are controlled for maintaining a substantially constant outlet pressure. In one embodiment, the pumps 24 and 26 are axial piston pumps having a movable swashplate, however, any type of hydraulic pumps capable of varied displacement may be used. A power source 28 is connected to the pumps 24 and 26 and is operable for driving the pumps. The power source 28 may include a combustion engine, an electric motor, or any other known source of motive power. During operation for pumping fluid, pump 24 pulls fluid from a tank 30 and provides the fluid into supply conduit 34. Likewise, during operation for pumping fluid, pump 26 pulls fluid from the tank 30 and provides the fluid into supply conduit 36.

The hydraulic circuit 10 of FIG. 1 also includes a plurality of valves associated with the actuator 12 for controlling the flow of fluid into and out of the actuator. The valves include two supply side valves 40 and 42, and two return side valves 44 and 46. In an alternative embodiment, the two return side valves may be combined into a single three-position valve. The hydraulic circuit 10 may optionally include a mixing valve 48. As the hydraulic circuit 10 of FIG. 1 includes only a single actuator 12, a single mixing valve 48 is included in the circuit. When a hydraulic circuit includes more than one actuator, one or more mixing valves may be used. Supply side valve 40 is connected between and controls the flow of fluid between supply conduit 34 and a conduit 54 leading to the head side chamber 14 of the actuator 12. Supply side valve 42 is connected between and controls the flow of fluid between supply conduit 36 and a conduit 56 leading to the rod side chamber 18 of the actuator 12. Return valve 44 is connected between and controls the flow of fluid between conduit 54 and a return conduit 58. Similarly, return valve 46 is connected between and controls the flow of fluid between conduit 56 and the return conduit 58. The mixing valve 48 connects and controls the flow between supply conduits 34 and 36.

FIG. 1 illustrates each valve 40, 42, 44, 46, and 48 as a bi-directional pressure compensating valve. The valves, however, can be any known type of valve including uni-directional valves. The use of bi-directional valves for at least the supply valves 40 and 42 and the mixing valve 48, however, enables additional control modes for the hydraulic circuit 10, as is discussed below.

FIG. 1 also illustrates an optional fluid power storage sub-system 70. The fluid power storage sub-system 70 includes an accumulator 72, an associated valve 74 and, optionally, a charge pump 76. The charge pump 76 is operatively connected to the pumps 24 and 26 and the power source 28. FIG. 1 illustrates a common shaft driving the pumps 24 and 26 and the charge pump 76. The charge pump 76 is operable for pulling fluid from the tank 30 and providing the fluid to the accumulator 72 via charge conduit 78 for filling the accumulator. A check valve 80 located in charge conduit 78 prevents fluid from the accumulator 72 from flowing back through the charge conduit 78 toward charge pump 76. The valve 74 connects the accumulator 72 to conduit 54 and controls a flow of fluid out of the accumulator. The valve 74 is a bi-directional valve for enabling the accumulator 72 to provide fluid to the conduit 54 and for enabling the conduit 54 to provide fluid to the accumulator 72.

The hydraulic circuit 10 also includes an electronic controller 64. The controller 64 is operatively connected to and controls the operation of the valves 40, 42, 44, 46, 48, and 74. The controller 64 is response to input signals provided from an operator input device 66 for controlling the valves 40, 42, 44, 48, and 74 in a manner for operating the actuator as desired by an operator. Each of the valves 40, 42, 44, 46, and 48 is responsive to the control signals for opening and closing to control the flow of fluid through the valve. The controller 64 also may control the power source 28 or, alternatively, may communicate with another controller that controls the power source 28. The pumps 24 and 26 also may be responsive to the control signals from the controller 64 for changing their displacement, such as by changing an angle of their associated swashplates. Alternatively, the pumps 24 and 26 may be self-controlled to maintain a substantially constant pressure at their outputs.

With reference again to the pumps 24 and 26, pump 24 is the primary pump for supplying fluid for powering the actuator 12 for movement in a first direction, while pump 26 is the primary pump for supplying fluid for powering the actuator 12 for movement in a second direction, opposite the first direction. FIG. 1 illustrates pump 24 as the primary pump for providing fluid to the head side chamber 14 of the actuator 12 and, illustrates pump 26 as the primary pump for providing fluid to the rod side chamber 16 of the actuator 12. If the demand of the actuator 12 is such that the primary pump is insufficient for powering the actuator, the mixing valve 48 may be opened and the other pump an this operation, the secondary pump) may be used to supplement the flow of fluid provided by the primary pump.

The hydraulic circuit 10 of FIG. 1 has a variety of control modes. The controller 64 controls at least the valves 40, 42, 44, 46, 48, and 74 for controlling the flow of fluid through the hydraulic circuit 10. The controller 64 controls the valves 40, 42, 44, 46, 48, and 74 and optionally, controls the pumps 24 and 26, in a manner to provide the highest efficiency for the hydraulic circuit 10 while performing as commanded by the input signals received from operator input device 66.

To extend the actuator 12 of FIG. 1, fluid is provided to the head side chamber 14 of the actuator 12. In response to a pressure differential between the head side chamber 14 and the rod side chamber 16 of the actuator 12, the piston/rod assembly 15 moves and fluid exits the rod side chamber 16 of the actuator. Below are various control modes for extending the actuator 12 in the hydraulic circuit 10 of FIG. 1.
Operate the power source 28 to drive pump 24 while opening valve 40 to allow fluid to flow from pump 24 through conduit 34, valve 40, and conduit 54 to the head side chamber 14 of the actuator 12. Valve 46 is opened to allow fluid exiting the rod side chamber 16 to flow to tank 30 via conduit 56, valve 46, and conduit 58.
Open valve 74 to allow fluid to flow from the accumulator 72 through valve 74 and a portion of conduit 54 to the head side chamber 14 of the actuator 12. Valve 46 is opened to allow fluid exiting the rod side chamber 16 to flow to tank 30 via conduit 56, valve 46, and conduit 58.
Open both valves 40 and 74 and operate to the pump 24 so that the pump 24 and the accumulator 72 both provide fluid to the head side chamber 14 of the actuator 12. Valve 46 is opened to allow fluid exiting the rod side chamber 16 to flow to tank 30 via conduit 56, valve 46, and conduit 58. This control mode is used when pump 24 is insufficient to operate the actuator 12 as commanded by the operator input device 66 and the accumulator 72 is used to supplement the fluid flow from pump 24.
In the event that the flow from pump 24 and the accumulator 72 is insufficient for powering the actuator 12 as commanded, valve 74 associated with the accumulator 72 may be closed and the mixing valve 48 may be opened so that pump 26 may be used to supplement (or augment) flow to the head side chamber 14 of the actuator 12. Valve 46 is opened to allow fluid exiting the rod side chamber 16 to flow to tank 30 via conduit 56, valve 46, and conduit 58. In this control mode, pump 24 is the primary pump and pump 26 is a secondary pump that supplements the flow of pump 24. Instead of both pumps 24 and 26 operating at partial displacement, pump 24 (the primary pump) is operated at full displacement and additional flow is supplemented by pump 26 (the secondary pump). The accumulator 72 may be used, as necessary, for further supplementing the flow provided from pumps 24 and 26.
To utilize the energy of the fluid exiting the rod side chamber 16 of the actuator 12, valve 46 may be controlled to remain closed and valve 42 may be opened to direct the flow to pump 26, which is controlled (or actuated) overcenter so as to act as a motor. Pump 26, acting as a motor, drives pump 24 (or aids the power source 28 in driving pump 24) for providing fluid to the head side chamber 14. The accumulator 72 may be used, as necessary, for further supplementing the flow from pump 24. Additionally, charge pump 76 is driven by pump 26 acting as a motor so that the accumulator 72 may be charged during this control mode.
In another control mode, the flow of fluid exiting the rod side chamber 16, after passing through valve 42, may be directed through the mixing valve 48 to supply conduit 34 to supplement (or augment) the flow from pump 24 as possible given the pressures in the supply conduits 34 and 36.

To retract the actuator 12, fluid is provided to the rod side chamber 16 of the actuator 12. In response to a pressure differential between the rod side chamber 16 and the head side chamber 14 of the actuator 12, the piston/rod assembly 15 moves and fluid exits the head side chamber 14 of the actuator 12. Below are various control modes for retracting the actuator 12 in the hydraulic circuit of FIG. 1.
Operate the power source 28 to drive pump 26 while opening valve 42 to allow fluid to flow from pump 26 through conduit 36, valve 42, and conduit 56 to the rod side chamber 16 of the actuator 12. Valve 44 is opened to allow fluid exiting the head side chamber 14 via conduit 54 to flow to one or both of the tank 30 and, if valve 74 is opened, the accumulator 72 to at least partially fill the accumulator.
In the event that the flow from pump 26 is not sufficient for powering the actuator 12 as commanded, the mixing valve 48 may be opened and pump 24 may be used to supplement (or augment) flow to the rod side chamber 16 of the actuator 12. Valve 44 is opened to allow fluid exiting the head side chamber 14 via conduit 54 to flow to one or both of the tank 30 and, if valve 74 is opened, the accumulator 72. In this control mode, pump 26 is the primary pump and pump 24 is a secondary pump that supplements the flow of pump 26. Instead of both pumps 24 and 26 operating at partial displacement, pump 26 (the primary pump) is operated at full displacement and additional flow is supplemented by pump 24 (the secondary pump).
To utilize the energy of the fluid exiting the head side chamber 14 of the actuator 12, valve 44 remains closed and valve 40 is opened to direct the flow to pump 24, which is controlled overcenter to act as a motor. Pump, 24 acting as a motor, drives pump 26 (or aids in driving pump 26) for providing fluid to the rod side chamber 16.
In another mode, some of the flow of fluid exiting the head side chamber 14, after passing through valve 40, may be directed through the mixing valve 48 to supply conduit 36 for regeneration back to the rod side chamber 16. The remainder of the fluid exiting the head side chamber 14 is directed to one of the accumulator 72 or the tank 30.

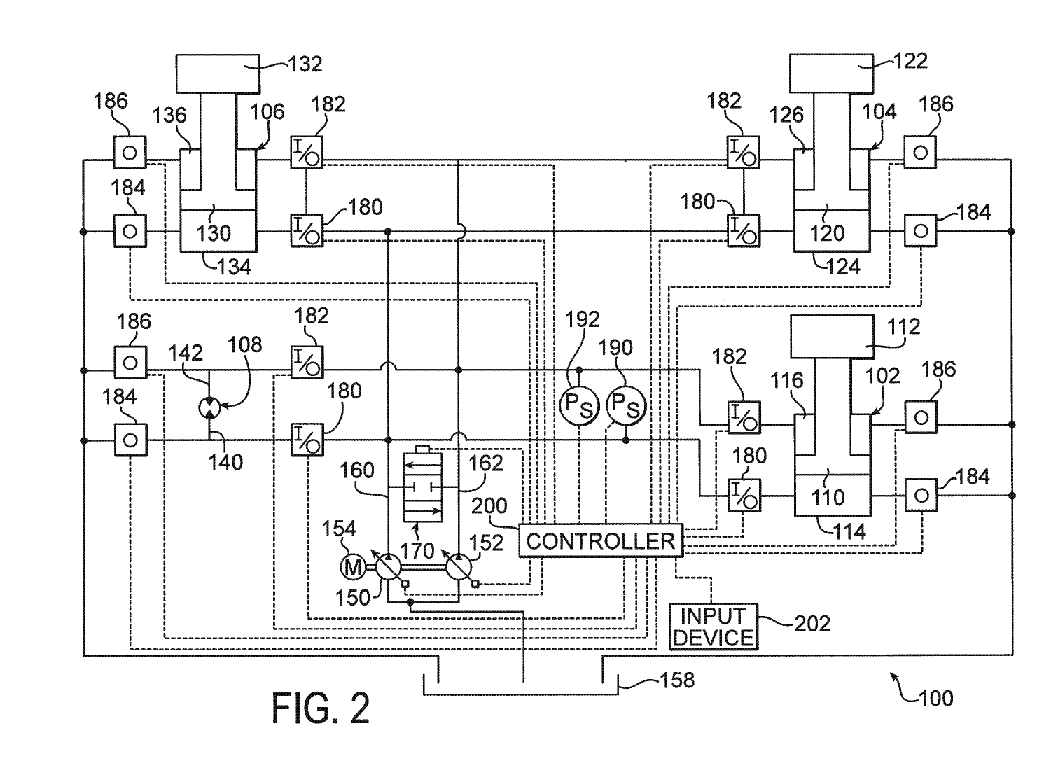

FIG. 2 illustrates a hydraulic circuit 100 constructed in accordance with another embodiment of the invention. The hydraulic circuit 100 includes multiple actuators. The actuators illustrated in FIG. 2 include three linear actuators 102, 104, and 106 and one rotary actuator 108; however, any type or combination of types or actuators may be included in the hydraulic circuit 100. Actuator 102 includes a piston/rod assembly 110 that is movable for actuating its associated function, shown generally by reference numeral 112. The piston/rod assembly 110 separates a head side chamber 114 and a rod side chamber 116 of the actuator 102. Actuator 104 includes a piston/rod assembly 120 that is movable for actuating its associated function, shown generally by reference numeral 122. The piston/rod assembly 120 separates a head side chamber 124 and a rod side chamber 126 of the actuator 104. Similarly, actuator 106 includes a piston/rod assembly 130 that is movable for actuating its associated function, shown generally by reference numeral 132. The piston/rod assembly 130 separates a head side chamber 134 and a rod side chamber 136 of the actuator 106. Actuator 108 includes first and second ports 140 and 142, respectively. Fluid entering the first port 140 tends to cause clockwise rotation (or movement in a first direction) of a rotating portion of the actuator 108. Fluid entering the second port 142 tends to cause counter-clockwise rotation (or movement in a second direction) of a rotating portion of the actuator 108.

The hydraulic circuit 100 also includes two hydraulic pumps 150 and 152. The pumps 150 and 152 are variable displacement pumps that may be actuated overcenter so as to act like motors. The pumps 150 and 152 are controlled for maintaining a substantially constant outlet pressure. In one embodiment, the pumps 150 and 152 are axial piston pumps having a movable swashplate, however, any type of hydraulic pumps capable of varied displacement may be used. A power source 154 is connected to the pumps 150 and 152 and is operable for driving the pumps. During operation for pumping fluid, pump 150 pulls fluid from a tank 158 and provides fluid into supply conduit 160. Likewise, during operation for pumping fluid, pump 152 pulls fluid from the tank 158 and provides fluid into supply conduit 162.

As can be seen with reference to FIG. 2, pump 150 is connected via conduit 160 to one side of each actuator. FIG. 2 illustrates pump 150 connected to the head side chambers 114, 124, and 134 of each of actuators 102, 104, and 106, respectively, and to the first port 140 of actuator 108. Thus, in the example illustrated in FIG. 2, pump 150 acts as a primary pump for supplying fluid for powering actuators 102, 104, and 106 for movement in an extending direction and for powering actuator 108 for clockwise rotation. In FIG. 2, pump 152 is connected via conduit 162 to the rod side chamber 116, 126, and 136 of each of actuators 102, 104, and 106 and to the second port 42 of actuator 108. Thus, in the example illustrated in FIG. 2, pump 152 acts as a primary pump for supplying fluid for powering actuators 102, 104, and 106 for movement in a retracting direction and for powering actuator 108 for counter-clockwise rotation.

FIG. 2 also illustrates an optional mixing valve 170 for fluidly connecting supply conduits 160 and 162. The mixing valve 170 illustrated in FIG. 2 is a three-position valve that is biased into a neutral (closed) position. The mixing valve 170 may be actuated to a first position for connecting flow from supply conduit 160 to supply conduit 162 or, may be actuated to a second position for connecting flow from supply conduit 162 to supply conduit 160. Flow between the supply conduits 160 and 162 enables the pumps 150 and 152 to combine flows, if necessary, so that one pump may supplement the flow of the other pump as described with reference to FIG. 1.

The hydraulic circuit 100 of FIG. 2 also includes a plurality of valves for controlling the flow of fluid into and out of each of the actuators 102, 104, 106, and 108. In FIG. 2, each actuator 102, 104, 106, and 108 includes four valves. The four valves include two supply side valves 180 and 182 and two return side valves 184 and 186. In the illustrated embodiment, at least the supply side valves 180 and 182 are bi-directional valves, such as, for example, bi-directional pressure compensating valves similar to those illustrated in FIG. 1. The return side valves 184 and 186 may be similar to the supply side valves 180 and 182 or simply may be two-position uni-directional valves for either blocking flow to tank 158 or enabling flow to tank 158. Alternatively, the return side valves may be combined into a single three-position valve.

FIG. 2 also illustrates two pressure sensors 190 and 192. Pressure sensor 190 is adapted for sensing the pressure within supply conduit 160 and for outputting a pressure signal indicative of the sensed pressure. Similarly, pressure sensor 192 is adapted for sensing the pressure within supply conduit 162 and for outputting a pressure signal indicative of the sensed pressure.

The hydraulic circuit 100 of FIG. 2 also includes a controller 200. The controller 200 receives signals from the pressure sensors 190 and 192 and also receives signals from an input device 202. The input device 202 may be, for example, a joystick for receiving commands from an operator, in which case the signals from the input device 202 are indicative of the operator commanded actuation of the actuators 102, 104, 106, and 108. The controller 200 is responsive to the input signals from the input device 202 and the pressure signals from the pressure sensors 190 and 192 for controlling the pumps 150 and 152 and the valves 170, 180, 182, 184, and 186 of the hydraulic circuit 100 in a manner to provide the highest efficiency while performing as commanded. The controller 200 also may prioritize actuation of the various actuators 102, 104, 106, and 108 and control the valves 170, 180, 182, 184, and 186 in a manner for providing priority to one or more actuators. Various control modes for the hydraulic circuit 100 of FIG. 2 are described below. These described control modes do not provide priority to any of the actuators. From the description provided, those skilled in the art should recognize how to control the valves 170, 180, 182, 184, and 186 in a manner for providing priority to one or more actuators.

To extend one or more of the actuators 102, 104, and 106 and/or cause clockwise rotation of actuator 108, the hydraulic circuit 100 of FIG. 2 is controlled in one of the following control modes:
Operate the power source 154 to drive pump 150 while opening the supply side valves 180 of the actuators 102, 104, 106, and 108 to allow fluid to flow from conduit 160 to the appropriate head side chamber 114, 124, 134, respectively, of the actuators 102, 104, and 106 to be extended and/or to the first port 40 of rotary actuator 108. Appropriate return side valves 186 of the actuators 102, 104, 106, and 108 are opened to allow fluid exiting the actuators to flow to tank 158.
In the event that the flow from pump 150 is not sufficient for powering the actuators 102, 104, 106, and 108 as commanded, the mixing valve 170 is opened and pump 152 is used as a secondary source to supplement (or augment) fluid flow to the head side chambers of the actuators 102, 104, and 106 to be extended and/or to the first port 40 of the rotary actuator 108. The controller 200 may make a determination that pump 150 is not sufficient for powering actuators 102, 104, 106, and 108 by monitoring pressure sensor 190. Alternatively, if supply side valve 180 is a pressure compensating valve, the controller 200 may monitor a position of the compensator for determining whether pump 150 is sufficient for powering actuators 102, 104, 106, and 108. As the compensator has a moving spool (or poppet) that moves in response to changes in pressure, the position of the spool (or poppet) is indicative of pressure. Thus, the compensator acts as the pressure sensor. Appropriate return side valves 186 of the actuators 102, 104, 106, and 108 are opened to allow fluid exiting the actuators to flow to tank 158.
To utilize the energy of the fluid exiting the actuators 102, 104, 106, and 108, fluid is supplied to the actuators 102, 104, 106, and 108 as set forth above and the return side valves 186 are controlled to the closed position. The supply side valves 182 are opened to direct the fluid flow exiting the actuators to pump 152, which is controlled overcenter to act as a motor. Pump 152, acting as a motor, drives pump 150 (or aids in driving pump 150) for providing fluid.
In another mode, the flow of fluid exiting the rod side chamber of the one or more actuators being extended, for example, chamber 126 of actuator 104, may be directed through the supply side valve 182 into conduit 162. The fluid may pass from conduit 162 through the mixing valve 170 (when appropriately positioned) and into conduit 160 to be directed into chamber 124 of actuator 104, via supply side valve 180 as possible given pressures in the conduits 160 and 162.

To retract one or more of the actuators 102, 104, and 106 and/or cause counter-clockwise rotation of actuator 108, the hydraulic circuit 100 is controlled in one of the following control modes:
Operate the power source 154 to drive pump 152 while opening the appropriate supply side valves 182 to actuators 102, 104, 106, and 108 to allow fluid to flow from conduit 162 to the appropriate rod side chamber 116, 126, 136, respectively, of the actuators 102, 104, and 106 to be retracted and/or to the second port 42 of the rotary actuator 108. Appropriate return side valves 184 of the actuators 102, 104, 106, and 108 are opened to allow fluid exiting the actuators to flow to tank 158.
In the event that the flow from pump 152 is not sufficient for powering the actuators 102, 104, 106, and 108 as commanded, the mixing valve 170 is opened and pump 150 is used as a secondary source to supplement (or augment) fluid flow to the rod side chambers of the actuators 102, 104, and 106 to be retracted and/or the second port 42 of the rotary actuator 108. The controller 200 may make a determination that pump 152 is not sufficient for powering actuators 102, 104, 106, and 108 by monitoring pressure sensor 192. Alternatively, if supply side valve 182 is a pressure compensating valve, the controller 200 may monitor a position of the compensator for determining whether pump 152 is sufficient for powering actuators 102, 104, 106, and 108. Appropriate return side valves 184 of the actuators 102, 104, 106, and 108 are opened to allow fluid exiting the actuators to flow to tank.
To utilize the energy of the fluid exiting the actuators 102, 104, 106, and 108, fluid is supplied to the actuators 102, 104, 106, and 108 as set forth above and the return side valves 184 are controlled to the closed position. The supply side valves 180 are opened to direct the fluid flow exiting the actuators to pump 150, which is controlled overcenter to act as a motor. Pump 150, acting as a motor, drives pump 152 (or aids in driving pump 152) for providing fluid.
In another mode, the flow of fluid exiting the head side chamber of one or more actuators being retracted, for example, chamber 124 of actuator 104, may be directed through the supply side valve 180 into conduit 160. The fluid may pass from conduit 160 through the mixing valve 170 (when appropriately positioned) and into conduit 162 to be directed into chamber 126 of actuator 104, via supply side valve 182 as possible given pressures in conduits 160 and 162.

At times, it may be desirable to actuate a majority of the actuators 102, 104, 106, and 108 in one direction and a minority of the actuators in an opposite direction. For example, assume that actuators 102 and 104 are commanded to extend, actuator 108 is commanded to rotate clockwise, and actuator 106 is commanded to retract. In such a scenario, pump 150, which based upon the commanded actuation acts as the primary fluid source for the majority of the actuators 102, 104, and 108, may be used for powering all of the actuators, including actuator 106, if capable. To power actuator 106 with fluid from pump 150, the controller 200 opens mixing valve 170 to enable fluid flow from supply conduit 160 into supply conduit 162 and valves 182 and 184 associated with actuator 106 are opened for enabling fluid flow into chamber 136 and out of the chamber 134. In the event that pump 150 is incapable of supplying sufficient fluid for actuating the actuators 102, 104, 106, and 108 as desired, the controller 200 will close the mixing valve 170 and supply fluid for actuator 106 from pump 152.

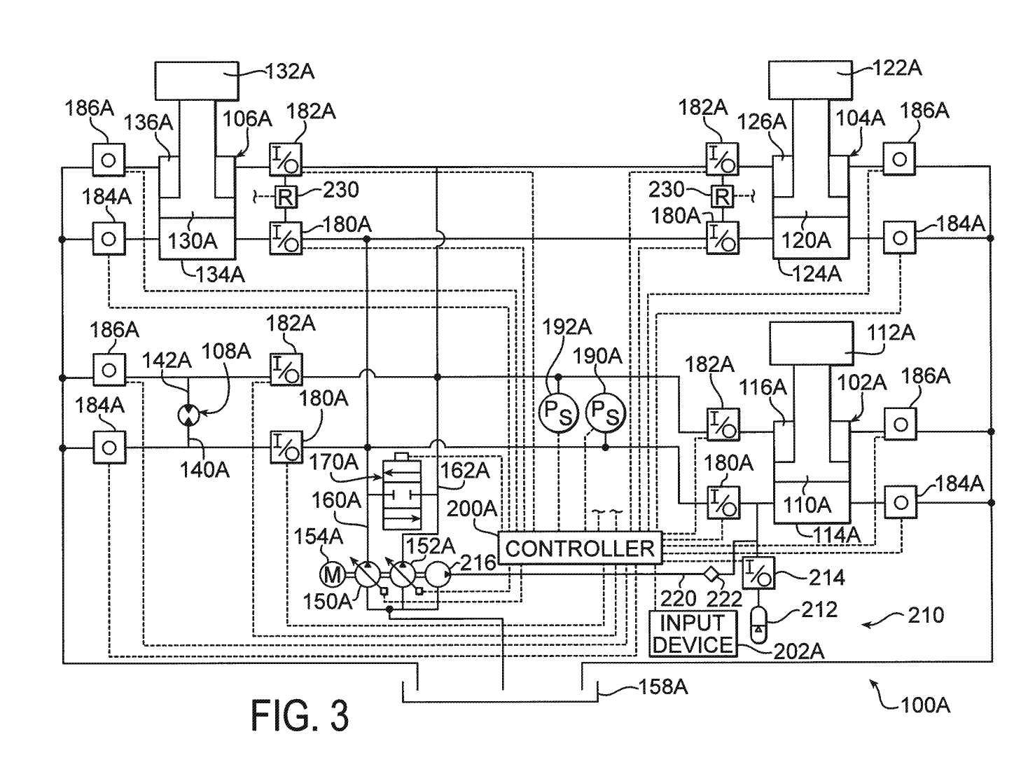

FIG. 3 illustrates a hydraulic circuit 100A constructed in accordance with yet another embodiment of the invention. Portions of FIG. 3 that are similar to those described above with reference to FIG. 2 use the same reference number as used in FIG. 2 with the addition of the suffix “A” and are not described in detail with reference to FIG. 3. The hydraulic circuit 100A of FIG. 3 includes a fluid power storage sub-system 210 associated with actuator 102A. Those skilled in the art should recognize that the other actuators 104A, 106A, and 108A may include a similar fluid power storage sub-system or multiple actuators may share a common fluid power storage sub-system. The fluid power storage sub-system 210 includes an accumulator 212, an associated valve 214 and a charge pump 216 that is coupled to and driven by the power source 154A. When a hydraulic circuit includes multiple fluid power storage sub-systems a common charge pump may be used. The charge pump 216 is operatively connected to the pumps 150A and 152A and the power source 154A. The charge pump 216 is operable for pulling fluid from the tank 158A and providing the fluid to the accumulator 212 via conduit 220 for filling the accumulator. A check valve 222 located in conduit 220 prevents fluid from the accumulator 212 from flowing back through conduit 220 toward charge pump 216. The valve 214 connects the accumulator 212 to supply conduit 160A. The valve 214 is a bi-directional valve for enabling the accumulator 212 to provide fluid to the supply conduit 160A and for enabling the supply conduit 160A to provide fluid to the accumulator 212. Fluid from the accumulator 212 may be used alone or in combination with fluid from pump 150A (and supplemental pump 152) for extending actuator 102A. The accumulator 212 may be charged by fluid provided by the charge pump 216, by fluid exiting the head side chamber 114A of the actuator 102A, by fluid provided by pump 150A, or by a combination of the these devices.

FIG. 3 also illustrates two actuators 104A and 106A having regeneration valves 230 that enable the supply side valves 180A and 182A to be fluidly connected. The regeneration valve 230 illustrated in FIG. 3 is merely representative and may be formed by structures integral with the supply side valves 180A and 182A. Those skilled in the art should recognize that any number of the actuators may include regeneration valves 230. The regeneration valves 230 direct fluid flowing out of a chamber with a volume that is being reduced and into a chamber with a volume that is being expanded. The control modes of the hydraulic circuit 100A in FIG. 3 are similar to those described with reference to FIG. 2 with the addition of the use of the fluid power storage sub-system 210 for actuator 102A, which is similar to that described with reference to fluid power storage sub-system 70 in FIG. 1, and the use of the regeneration valves 230 for actuators 104A and 106A.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention.

What is claimed is:

1. A hydraulic circuit comprising:
at least one actuator that may be powered for performing a function;
a plurality of valves associated with the at least one actuator for controlling a flow of fluid into and out of the at least one actuator;
multiple pumps for supplying fluid to the at least one actuator, the multiple pumps including a first pump for primarily powering the at least one actuator for movement in a first direction and a second pump for primarily powering the at least one actuator for movement in a second direction, opposite the first direction.

2. The hydraulic circuit of claim 1 further including an electronic controller for controlling the valves, the controller being responsive to signals from an input device for controlling the valves.

3. The hydraulic circuit of claim 2 wherein the first pump provides fluid into a first supply conduit, the second pump provides fluid into a second supply conduit, and a mixing valve is connected between the first and second supply conduits, the mixing valve being responsive to the controller for fluidly connecting the first and second supply conduits.

4. The hydraulic circuit of claim 3 wherein the mixing valve is a bi-directional pressure compensating valve that may be opened for enabling the second pump to supplement the first pump for powering movement the at least one actuator in the first direction and for enabling the first pump to supplement the second pump for powering movement the at least one actuator in the second direction.

5. The hydraulic circuit of claim 3 wherein the mixing valve is a three-position valve that is biased into a neutral position blocking flow between the first and second supply conduits, the mixing valve adapted to be actuated into a first position for enabling a flow of fluid from the first supply conduit to the second supply conduit for enabling the first pump to supplement the second pump for powering movement the at least one actuator in the second direction and adapted to be actuated into a second position for enabling a flow of fluid from the second supply conduit to the first supply conduit for enabling the second pump to supplement the first pump for powering movement the at least one actuator in the first direction.

6. The hydraulic circuit of claim 3 further including a first pressure sensor for sensing fluid pressure in the first supply conduit and providing a first pressure signal to the controller, a second pressure sensor for sensing fluid pressure in the second supply conduit and providing a second pressure signal to the controller, the controller being responsive to the first and second pressure signals and signals from an input device for controlling the first and second pumps and the mixing valve.

7. The hydraulic circuit of claim 2 further including a fluid power storage sub-system having an accumulator and a valve for controlling a flow of fluid out of the accumulator, the controller controlling the valve of the fluid power storage sub-system for powering the at least one actuator using fluid from the accumulator.

8. The hydraulic circuit of claim 7 wherein the valve of the fluid power storage sub-system further controls a flow of fluid into the accumulator from the at least one actuator, the accumulator being at least partially filled by the fluid received from the at least one actuator.

9. The hydraulic circuit of claim 8 wherein the fluid power storage sub-system further includes a charge pump for providing fluid to the accumulator for filling the accumulator, a fluid conduit between the charge pump and the accumulator including a check valve for preventing fluid from flowing from the accumulator toward the charge pump.

10. The hydraulic circuit of claim 2 wherein the plurality of valves includes two supply side valves and two return side valves, one of the supply side valves and one of the return side valves generally being associated with movement of the at least one actuator in the first direction, and the other one of the supply side valves and the other one of the return side valves generally being associated with movement of the at least one actuator in the second direction.

11. The hydraulic circuit of claim 10 wherein one of the first and second pumps is an overcenter pump that may be operated as a motor, the controller being adapted to control the supply side valves so as to direct fluid exiting the at least one actuator to the overcenter pump operating as a motor, the overcenter pump operating as a motor driving the other one of the first and second pumps.

12. The hydraulic circuit of claim 10 further including a regeneration valve that enable the two supply side valves to be fluidly connected, the regeneration valve being controlled by the controller and opening to direct fluid exiting a chamber of the at least one actuator that is reducing in volume into a chamber of the at least one actuator that is increasing in volume.

13. The hydraulic circuit of claim 2 wherein the at least one actuator includes a plurality of actuators, each one of the plurality of actuators including two supply side valves and two return side valves, one of the supply side valves and one of the return side valves generally being associated with movement of the actuator in the first direction, and the other one of the supply side valves and the other one of the return side valves generally being associated with movement of the actuator in the second direction.

14. The hydraulic circuit of claim 13 further including a mixing valve for connecting supply conduits associated with the first and second pumps, the controller, in response to signals from an input device commanding movement of a majority of the actuators in the first direction and commanding movement of a minority of actuators in the second direction, controlling the mixing valve to open to enable the first pump to provide fluid for powering the movement of all of the actuators when the first pump has sufficient capacity to power the actuators as commanded.

15. The hydraulic circuit of claim 14 wherein the plurality of actuators includes a linear actuator and a rotary actuator.

16. The hydraulic circuit of claim 13 wherein the first pump provides fluid into a first supply conduit, the second pump provides fluid into a second supply conduit, and a mixing valve is connected between the first and second supply conduits, the mixing valve being responsive to the controller for fluidly connecting the first and second supply conduits and, wherein the controller is responsive to signals from an input device for controlling movement of the actuators, the controller, in response to signals from the input device indicating a desire to move a majority of actuators in the first direction and a minority of actuators in a second direction, opening the mixing valve and attempting to supply fluid for powering all of the actuators with the first pump.
